(19) United States
(12) Patent Application Publication
(10) Pub. No.: US 2004/0128895 A1
(43) Pub. Date: Jul. 8, 2004

(54) Display assembly

(75) Inventor: Chantal Marie Josee Trudel, Toronto (CA)

Correspondence Address: Robert P. Simpson, Esq., Simpson & Simpson, PLLC, 5555 Main Street, Williamsville, NY, 14221-5406, US

(73) Assignee: Umbra Inc., Buffalo, NY

(21) Appl. No.: 10/336,131

(22) Filed: Jan. 3, 2003

(51) Int. Cl. A47G 1/16; G09F 3/18; A47G 1/06

(52) U.S. Cl. 40/761; 40/771; 40/661

(57) ABSTRACT

A display assembly having a base having a perimeter, the base has a first groove extending across the base in communication with and through to the perimeter, and at least a pair of second grooves extending transversely with respect to the first groove, and, at least one display element operatively arranged to be held in one of the first and/or second groove(s). A display assembly having a round (circular) base having a circumference, the base including at least three grooves extending diametrically across the base, wherein the grooves intersect one another at a common point, wherein at least one of the at least three grooves extend to the circumference of the base, and, at least one display element operatively arranged to be held in one of the at least three grooves. A display assembly having a rotatable base with intersecting grooves which extend through to a perimeter of the base.

### FIELD OF THE INVENTION

This invention relates generally to display assemblies and picture frames and, more particularly, to a display assembly for displaying one or more works of art.

### BACKGROUND OF THE INVENTION

The present invention relates generally to a display assembly for displaying a work of art. A variety of display assemblies for works of art are known in the art.

U.S. Pat. No. D358,176 (Atkinson) discloses an advertising display having a round base to which a pair of perpendicularly arranged interlocking frame members is secured. This patent discloses no slots or grooves in the base.

U.S. Pat. No. D361,455 (Eason) discloses a trading card display system. The base of the system includes nine slots arranged in the pattern of defensive players on a baseball field. Some of the slots are parallel to one another, others at right angles, and still others at what appears to be a forty-five degree angle. The slots seem to be angled, in that FIG. 4 shows the cards being displayed at an angle other than 90° with respect to the base. The trading cards appear to be displayed in a u-shaped frame, also as shown in FIG. 4. The slots do not extend continuously from edge to edge along the base.

U.S. Pat. No. D382,017 (Bohr et al.) discloses a collectible card display having a base that includes a single angled groove therein for mounting a card. There is no teaching or suggestion of more than one groove, much less transverse grooves.

U.S. Pat. No. 2,499,535 (Spreen) discloses a photograph-mounting device including a base having a pair of perpendicularly arranged grooves therein. It also includes a pair of interlocking notched sheets that mount in the grooves, and a cap member grooved similarly to the base and arranged to secure the tops of the pair of sheets. Spreen does not teach or suggest non-interlocking frames, nor does he suggest anything other than a single pair of grooves in the base. Thus, a plurality of spaced apart works of art (i.e., in a plurality of spaced apart parallel planes) cannot be displayed using Spreen's invention.

U.S. Pat. No. 3,594,936 (Blum) discloses a display apparatus having a base containing slots, into which display panels may be secured. These display panels are arranged to lockingly engage one another at right angles. The slots in the base in Blum's invention are not continuous, nor do they extend from edge to edge of the base. Thus, works of art cannot extend beyond the perimeter when displayed with Blum's invention.

U.S. Pat. No. 4,263,732 (Gutierrez et al.) discloses a self-locking photographic print display frame having a base with a groove and pair of slots therein. Neither the groove nor the slots in this patented invention extend from edge to edge across the base. The display frame comprises a pair of members pivotally arranged with respect to one another. The members include tabs arranged to engage the groove and slots to lock the frame in place on the base. Thus, works of art cannot extend beyond the perimeter of the base when displayed with Gutierrez et al.'s invention.

What is needed, then, is a display assembly for works of art having a base with a first groove extending across the base in communication with and through to the perimeter of the base, and at least a pair of second grooves extending transversely with respect to the first groove, and at least one display element operatively arranged to be held in one of the first and second groove(s), such that the display element(s) can extend when displayed beyond the perimeter of the base.

### SUMMARY OF THE INVENTION

The present invention broadly comprises a display assembly having a base having a perimeter, the base including a first groove extending across the base in communication with and through to the perimeter, and at least a pair of second grooves extending transversely with respect to the first groove, and, at least one display element operatively arranged to be held in one of the first and/or second groove(s).

In another embodiment, the present invention broadly comprises a display assembly having a rectangular base having a perimeter formed by four sides, the base including a first groove extending across the base in communication with and through to the perimeter, the base further including at least a pair of second grooves extending transversely with respect to the first groove, wherein the first groove and at least a pair of the second grooves extend to the perimeter of at least one of the four sides of the rectangular base, and, at least one display element operatively arranged to be held in one of the first and/or second groove(s).

In another embodiment, the present invention broadly comprises a display assembly having a round (circular) base having a circumference, the base including at least three grooves extending diametrically across the circular base, wherein the at least three grooves intersect one another at a common point, wherein at least one of the at least three grooves extend to the circumference of the base, and, at least one display element operatively arranged to be held in one of the at least three grooves.

In another embodiment, the present invention broadly comprises a display assembly having a rotatable base, wherein the rotatable base includes a plurality of intersecting grooves, which grooves extend through to a perimeter of the base.

A general object of the invention is to provide a display assembly comprising a base which may be of various geometric shapes, which base comprises a plurality of grooves which intersect one another and extend to a perimeter of the base to enable display elements to extend beyond the base when displayed.

Another object of the invention is to provide a display assembly having a rotatable base for displaying display elements (which display elements hold works of art).

These and other objects, features, and advantages of the present invention will become readily apparent to those having ordinary skill in the art upon reading the following detailed description of the invention in view of the several drawings of the invention.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a first embodiment of the present invention as viewed from the left;

FIG. 2 is a perspective view of the first embodiment shown in FIG. 1, except viewed from the right, and with the individual works of art overhanging the base;

FIG. 3 is a perspective view of a second embodiment of the present invention;

FIG. 4 is an exploded perspective view of the first embodiment of the invention;

FIG. 5 is an end view of the base of the display assembly of the invention, as viewed from the right, facing side 11a, in FIG. 2;

FIG. 6 is a schematic top view of a third embodiment of the base of the invention;

FIG. 7 is a perspective view of a fourth embodiment of the base of the invention;

FIG. 8 is a perspective view of a fifth embodiment of the base of the invention;

FIG. 9 is a perspective view of a sixth embodiment of the base of the invention;

FIG. 10A is a perspective view of an alternative embodiment of the invention, illustrating a rotatable base of the display assembly; and,

FIG. 10B is a cross-sectional view of the base of the alternative embodiment shown in FIG. 10A, taken generally along line 10B in FIG. 10A.

### DETAILED DESCRIPTION OF THE INVENTION

At the outset, it should be appreciated that like drawing numbers on different drawing views identify identical structural elements of the invention. While the present invention is described with respect to what is presently considered to be the preferred embodiments, it is understood that the invention is not limited to the disclosed embodiments.

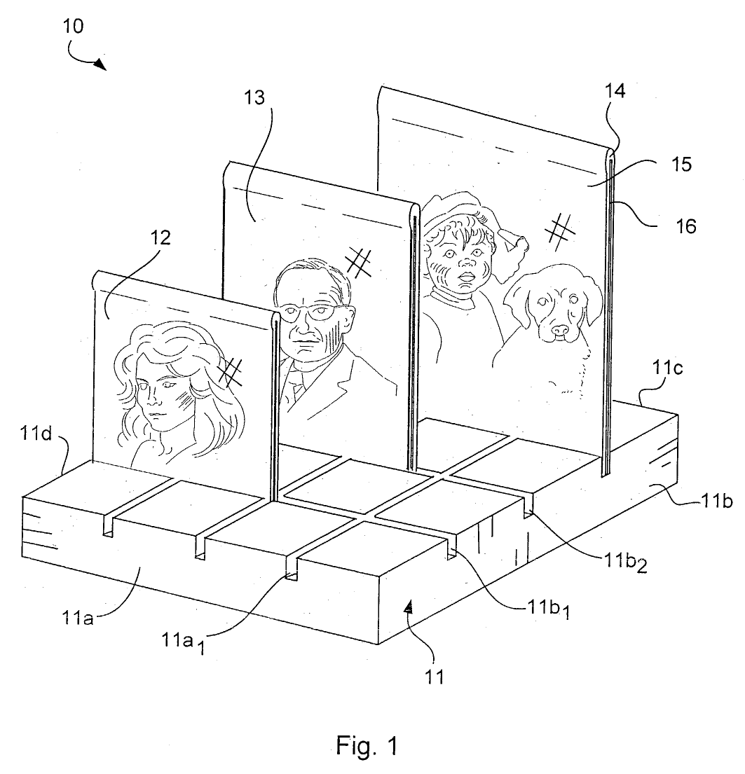

FIG. 1 is a perspective view of display assembly 10 of the present invention, as viewed from the left. Display assembly 10 of the invention broadly comprises base 11 and at least one display element 12, 13 or 15. (Although a plurality of display elements are shown in the drawings, only one display element is necessary.) In the embodiment shown in FIG. 1, base 11 is in the shape of a rectangle, although it should be appreciated by those having ordinary skill in the art, that the base can take the form of a variety of geometric shapes, including but not limited to round (circular), polygonal (triangular, rectangular, pentagonal, etc.), arcuate, non-symmetrical, etc.

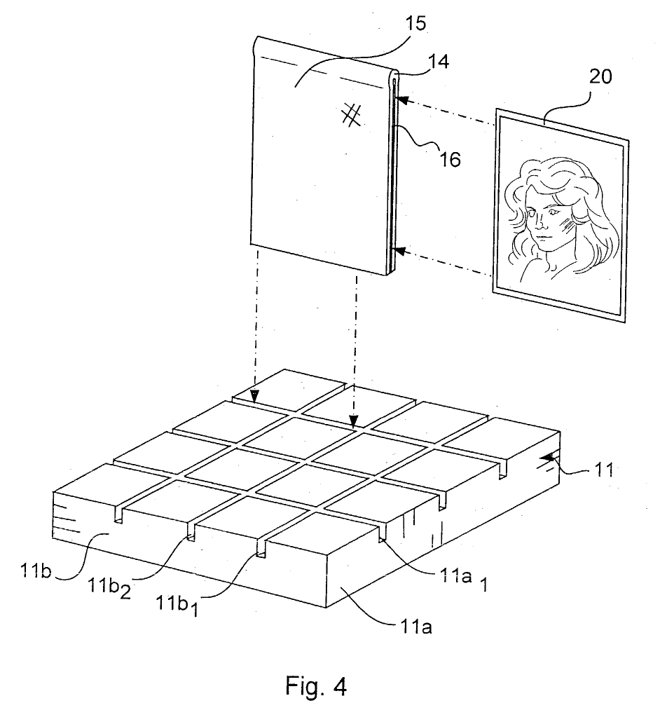

Adverting again to FIG. 1, base 11 of the display assembly is bounded by a perimeter comprising sides 11a, 11b, 11c and 11d. A first groove 11a, extends across the base from side 11a to side 11c (best shown in FIG. 4). The first groove extends through to the perimeter of the base, such that a display element disposed within the groove can extend beyond the perimeter of the base. The base further includes at least a pair of second grooves 11b₁ and 11b₂ (best shown in FIG. 4) that extend transversely with respect to first groove 11a₁. In the embodiment shown in FIG. 1, second grooves 11b₁ and 11b₂ also extend through to the perimeter of base 11, such that a display element (e.g., display elements 12, 13 and/or 15) disposed within any of the grooves can extend beyond the perimeter of the base. It should be noted that, although in the embodiment shown in FIG. 1, both the first and second grooves are shown to completely extend through to the perimeter, i.e., they are “open” grooves or slots, this embodiment is intended by the patentee to include a structure of the base where one or more of the first and second grooves is/are closed at one end thereof, such that only one end of the groove extends through to the perimeter, enabling a display element to extend outwardly at one edge or side of the base, and this “single closed end” groove embodiment is intended to be within the spirit and scope of the invention as claimed.

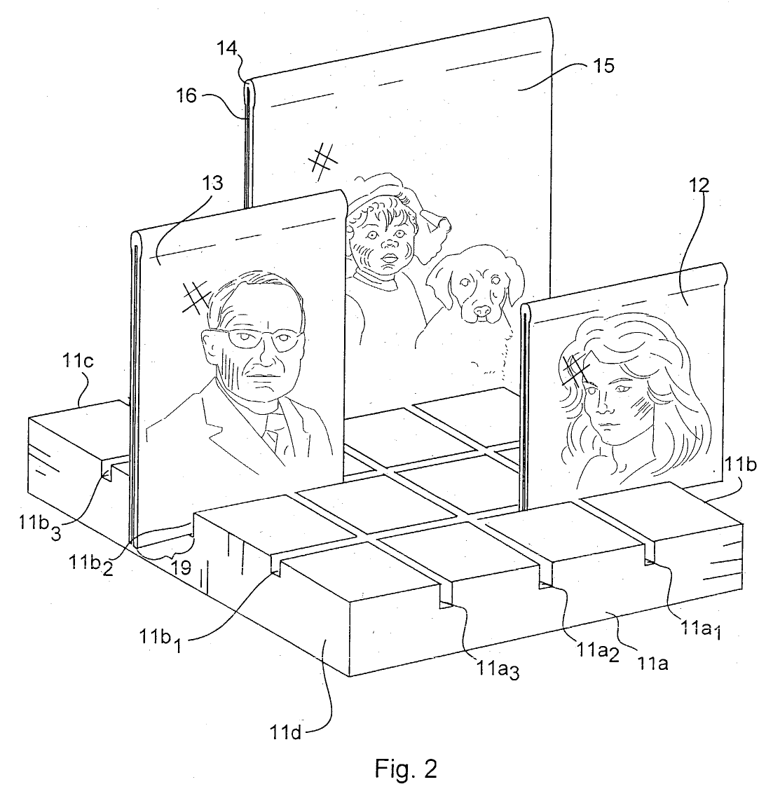

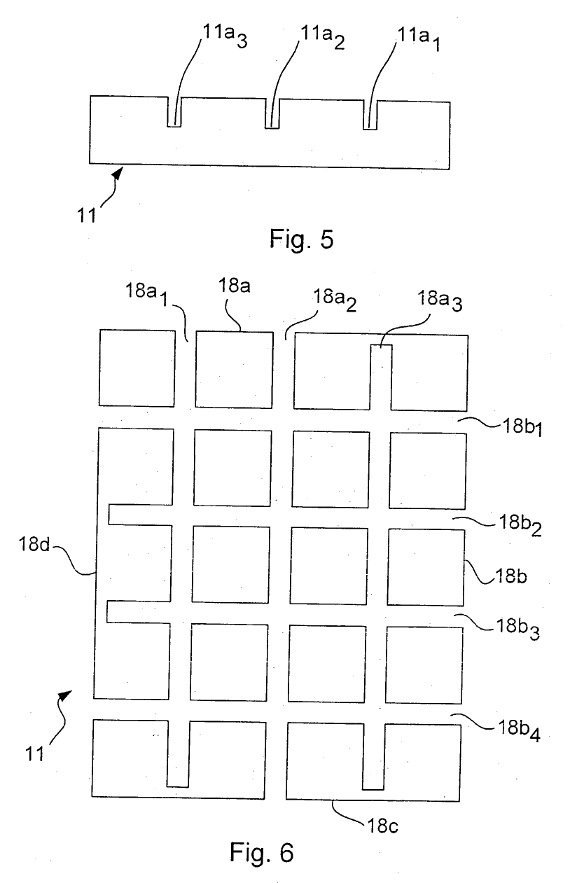

FIG. 2 is a perspective view of the present invention shown in FIG. 1, except viewed from the right. The cross section taken along groove 11b₁ is shown in FIG. 5. Display element 13 is disposed within groove 11b₂ that extends through to the perimeter of the base. Overhang 19 represents the extension of display element 13 beyond side 11d of base 11. This overhang is made possible by the fact that groove 11b₂ is open, i.e., it extends completely across the width of the base. All variations in the extent of the overhang, if any, are intended to be within the spirit and scope of the invention as claimed.

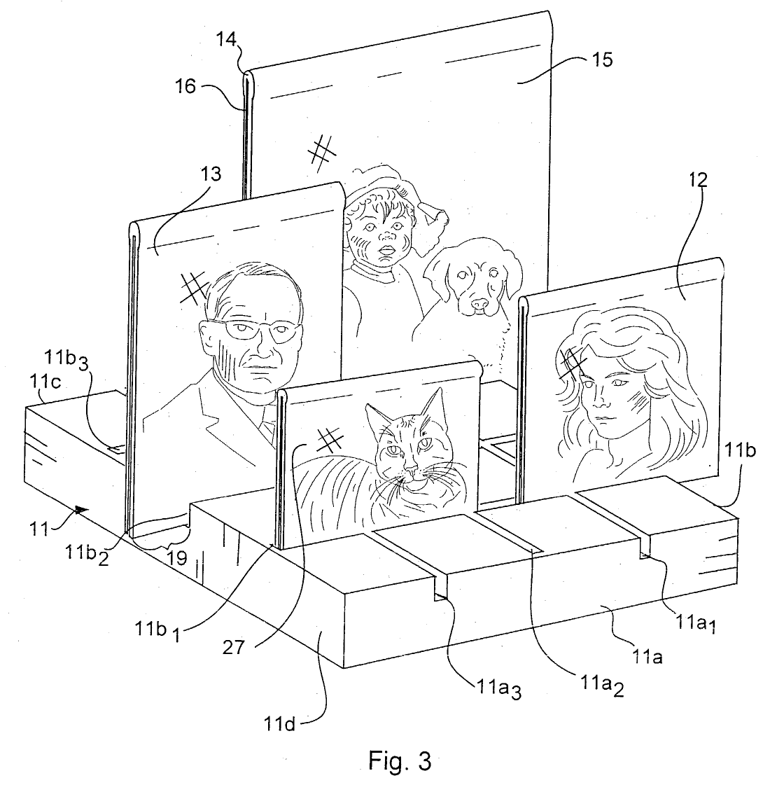

FIG. 3 is a perspective view of a second embodiment of the present invention. In the embodiment shown in FIG. 3, a plurality of display elements (12 and 27) are disposed within a “single closed end” groove 11b₁, Single closed end groove 11b₁, extends beyond the perimeter of the base (i.e. is “open”) beneath display element 12 but does not extend beyond the perimeter of the base (i.e. is “closed”) leftwardly adjacent to display element 27. This “single closed end” groove embodiment shows a structure of the base where one or more of the first (11a₂) and second (11b₁, 11b₂) grooves is/are closed at one end thereof, and open at the other, such that only one end of the groove extends through to the perimeter, enabling a display element to extend outwardly at only one edge or side of the base.

FIG. 4 is an exploded perspective view of the first embodiment of the invention. Display element 15 comprises U-shaped element 14, made of a transparent sheet material. In a preferred embodiment, element 14 is made of plastic, preferably acrylic, sheet. The plastic sheet is folded upon itself to form slit 16. Slit 16 is arranged to hold a work of art 20 for display. The term “work of art” includes, but is not limited to, drawings, paintings, collages, sports cards, and photographs.

FIG. 5 is an end view of base 11 of the display assembly of the invention, as viewed from the right, facing side 11a, in FIG. 2. All of the grooves, including first groove 11a₁, and grooves 11a₂ and 11a₃, are shown as being “open” and extending to the edge of side 11a of the base.

FIG. 6 is a top schematic view of a third embodiment of base 11 of the invention. A plurality of the various types of grooves is shown. For example, first groove 18a₂ is open and extends through to the edge of the perimeter of sides 18a and 18c of base 11. A pair of second grooves 18b₁ and 18b₄ that extend transversely with respect to first groove 18a₂, are also open and extend through to the edge of the perimeter of sides 18b and 8d. First groove 18a₁ represents a “single closed end” groove that is traversed by a pair of “single closed end” second grooves 18b₂ and 18b₃. A “closed” first groove 18a₃ is also shown (closed at both ends), transected by both an “open” second groove 18b₁ and a “single closed end” second groove 18b₂. It should be appreciated that various embodiments of the base including a plurality of grooves such as an “open” first groove, a pair of “open” second grooves, a “single closed end” first groove, a pair of “single closed end” second grooves, a “closed” first groove, and a pair of “closed” second grooves and variations, permutations and combinations thereof are intended to be within the spirit and scope of the invention as claimed.

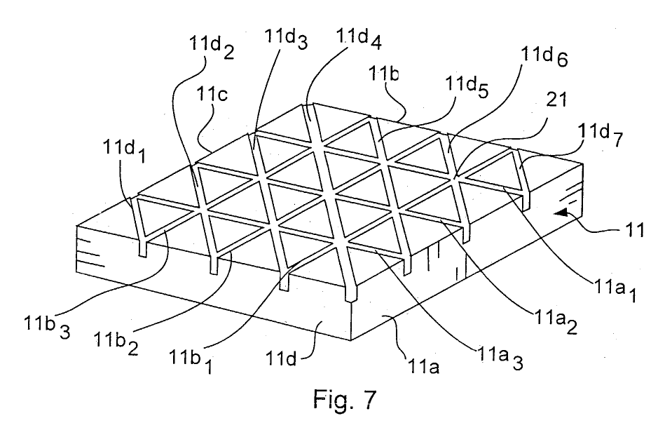

FIG. 7 is a perspective view of a fourth embodiment of base 11 of the invention. Base 11 is rectangular and has a first groove 11b₁, which extends across the base from side 11d to side 11b and is transected by a diagonal groove 11d₄. The base also includes at least a pair of second grooves 11a₃ and 11a₂, which extend transversely with respect to first groove 11b₁, and are transected by a diagonal groove 11d₅. Transection point 21 represents the common point at which grooves 11a₁, 11b₁ and 11d₆ meet. A plurality of additional diagonal grooves 11d₁, 11d₂, 11d₃ and 11d₇ may also optionally be included.

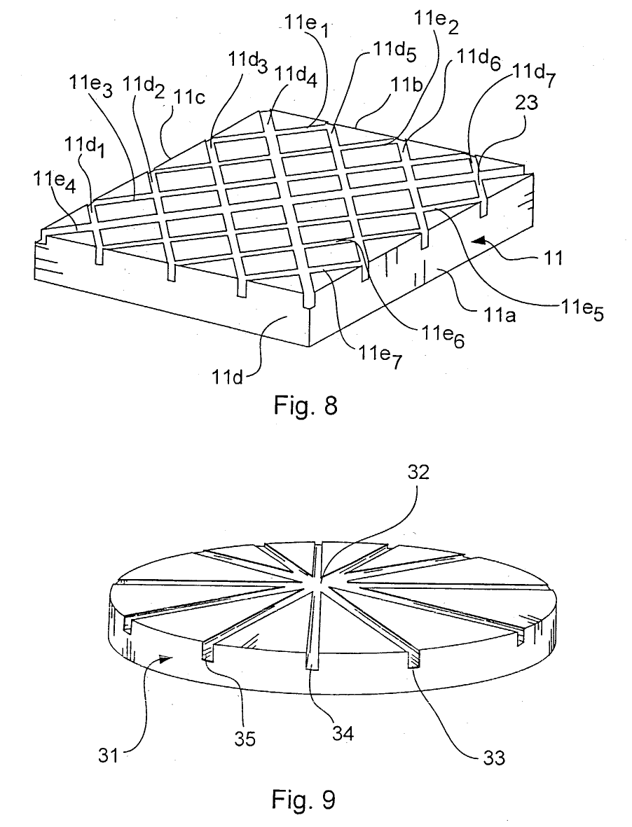

FIG. 8 is a perspective view of a fifth embodiment of base 11 of the invention. In this embodiment, base 11 is rectangular and is traversed by a plurality of diagonally intersecting grooves. First groove 11d₃ extends across the base from side 11c to side 11d. The base includes at least a pair of second grooves 11e₂ and 11e₃, which extend transversely with respect to first groove 11d₃, and extend across the base from side 11b to side 11c. It should be noted that, although in the embodiment shown in FIG. 8, all the grooves are arranged so as to form right angles, they can also simply be transverse, i.e., crossing at some angle other than 90 degrees. For example, second grooves 11e₂ and 11e₃ could be removed and replaced with the second grooves 11a₂ and 11a₃ from FIG. 7, such that the second grooves 11a₂ and 11a₃ traverse first groove 11d₃ at an angle other than 90 degrees. Variations, permutations and combinations on such an embodiment are also intended to be within the spirit and scope of the invention as claimed.

FIG. 9 is a perspective view of a sixth embodiment of the base of the invention. In this embodiment, base 31 is circular (round) and has at least open three grooves 33, 34, and 35, extending diametrically across circular base 31. The three grooves intersect one another at a common point 32. In the embodiment shown in FIG. 9, all of the grooves extend to the perimeter of circular base 31 (i.e., they are “open” grooves), such that a display element disposed within any of the grooves can extend beyond the perimeter of the base. It should be noted that, although in the embodiment shown in FIG. 9, all the grooves are shown to completely extend through to the perimeter, i.e., they are “open” grooves or slots, this embodiment is intended by the patentee to include a structure of the base where one or more of the grooves is/are closed at one end thereof, such that only one end of the groove extends through to the perimeter, enabling a display element to extend outwardly at one edge or side of the base, and this “single closed end” groove embodiment is intended to be within the spirit and scope of the invention as claimed. Finally, it should be noted that while all the grooves in FIG. 9 are arranged so as to form equivalent angles, they can also simply be transverse, i.e., crossing so as to form any angle between 0 and 360 degrees between any two adjacent grooves.

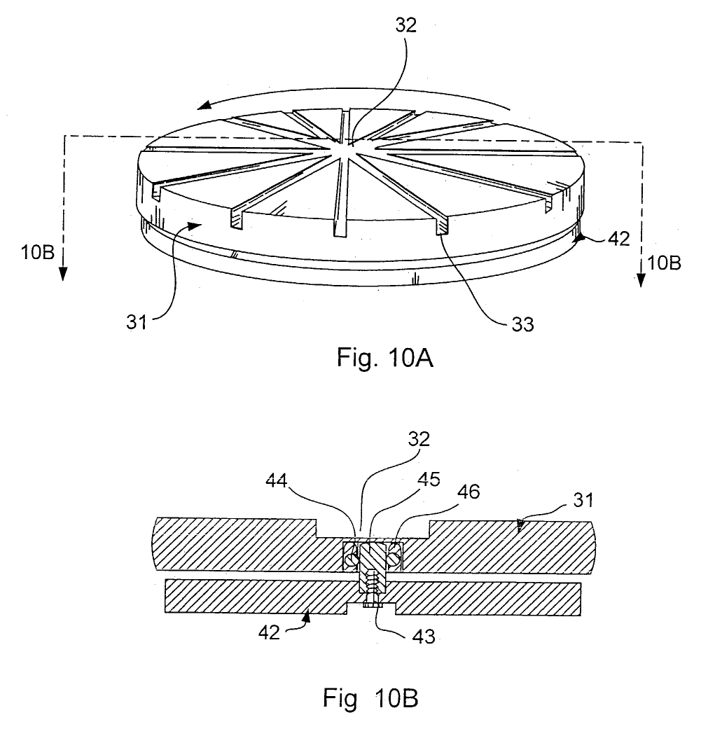

FIG. 10A is a perspective view of an alternative embodiment of the invention, illustrating a rotatable base 31 of the display assembly. In the embodiment shown in FIG. 10A, the rotatable base 31 is positioned atop stationary base 42. Rotatable base 31 is circular and arranged to freely rotate clockwise or counterclockwise relative to stationary base 42 in a “lazy-Susan” fashion. Both bases are shown in the shape of a circle, although it should be appreciated by those having ordinary skill in the art, that either base can take the form of a variety of geometric shapes, including but not limited to round (circular), polygonal (triangular, rectangular, pentagonal, etc.), arcuate, non-symmetrical, etc.

FIG. 10B is a cross-sectional view of the base of the alternative embodiment shown in FIG. 10A, taken generally along line 10B in FIG. 10A. Stationary base 42 includes screw 43, bearing 44, bearing casing 46 and armature 45 which facilitates rotation of the rotatable base 31 on its axis.

Thus it is seen that the objects of the invention are efficiently obtained, although changes and modifications to the invention should be readily apparent to those having ordinary skill in the art, which changes are considered to be within the scope of the invention as claimed. For example, the display assembly permits one to place a plurality of works of art on display in different planes, and in parallel spaced apart planes, etc. Also, while all of the disclosed embodiments arrange a plurality of display elements along the horizontal axis of the base, it is contemplated that the display elements may also be held in grooves such that they are at right angles to one another.

What is claimed is:

1. A display assembly, comprising:
a base having a perimeter, said base including a first groove extending across said base in communication with and through to said perimeter, and at least a pair of second grooves extending transversely with respect to said first groove, and,
at least one display element operatively arranged to be held in one of said first and second groove(s).

2. The display assembly recited in claim 1 wherein said at least a pair of second grooves extend across said base in communication with said perimeter, wherein said at least one display element may be arranged to extend outwardly beyond said perimeter when displayed.

3. The display assembly recited in claim 1 wherein said base is rectangular.

4. The display assembly recited in claim 1 wherein said base is circular.

5. The display assembly recited in claim 1 wherein said base is triangular.

6. The display assembly recited in claim 1 further comprising at least one additional groove in said base arranged parallel to said first groove and transversely with respect to said at least a pair of second grooves.

7. The display assembly recited in claim 1 wherein said at least a pair of second grooves are parallel to one another.

8. The display assembly recited in claim 1 wherein said first groove and said at least a pair of second grooves are perpendicular to one another.

9. The display assembly recited in claim 1, further comprising a third groove arranged transversely with respect to said first and second groove(s).

10. The display assembly recited in claim 1, wherein said display element comprises a U-shaped element.

11. The display assembly recited in claim 10, wherein said U-shaped display element comprises a transparent sheet folded upon itself, having a slit therein to hold a work of art to be displayed.

12. The display assembly recited in claim 10 wherein said U-shaped display element is plastic.

13. The display assembly recited in claim 1, wherein said base is rotatable.

14. A display assembly, comprising:
a rectangular base having a perimeter formed by four sides, said base including a first groove extending across said base in communication with and through to said perimeter, and at least a pair of second grooves extending transversely with respect to said first groove;
wherein said first groove and said at least a pair of second grooves extend to said perimeter of at least one of the four sides of said rectangular base; and,
at least one display element operatively arranged to be held in one of said first and second groove(s).

15. The display assembly recited in claim 14 wherein said at least a pair of second grooves extend across said rectangular base in communication with said perimeter, wherein said at least one display element may be arranged to extend outwardly beyond said perimeter when displayed.

16. The display assembly recited in claim 14 further comprising at least one additional groove in said base arranged parallel to said first groove and transversely with respect to said at least a pair of second grooves.

17. The display assembly recited in claim 14 wherein said at least a pair of second grooves are parallel to one another.

18. The display assembly recited in claim 14 wherein said first groove and said at least a pair of second grooves are perpendicular to one another.

19. A display assembly, comprising:
a circular base having a perimeter, said base including at least three grooves extending diametrically across said circular base,
said at least three grooves intersect one another at a common point,
with one of said at least three grooves extending to said perimeter of said circular base, and,
at least one display element operatively arranged to be held in one of said at least three grooves.

20. The display assembly recited in claim 19, wherein said base is rotatable.

21. The display assembly recited in claim 19, wherein said display element comprises a U-shaped element.

22. The display assembly recited in claim 21, wherein said U-shaped display element comprises a plastic sheet folded upon itself, having a slit therein to hold a work of art to be displayed.

23. The display assembly recited in claim 21, wherein said U-shaped display element is acrylic.

24. A display assembly, comprising:
a base having a perimeter, said base including a first groove extending across said base in communication with and through to said perimeter, and at least a pair of second grooves extending transversely with respect to said first groove, and,
at least two display elements operatively arranged to be held in a coplanar arrangement with one another in said first groove.

25. The display assembly of claim 24, wherein said at least two display elements are operatively arranged to be held in a coplanar arrangement with one another in one groove of said at least a pair of second grooves.
